(19) United States
(12) Patent Application Publication
(10) Pub. No.: US 2018/0019855 A1
(43) Pub. Date: Jan. 18, 2018

(54) METHOD AND DEVICE FOR REPORTING CSI BY UE AND TRIGGERING UE TO REPORT CSI

(71) Applicant: ZTE CORPORATION, Shenzhen City (CN)

(72) Inventors: Wen ZHANG, Shenzhen City (CN); Shuqiang XIA, Shenzhen City (CN); Bo DAI, Shenzhen City (CN); Jing SHI, Shenzhen City (CN)

(73) Assignee: ZTE CORPORATION, Shenzhen City (CN)

(21) Appl. No.: 15/547,581

(22) PCT Filed: Jan. 25, 2016
(86) PCT No.: PCT/CN2016/071976

§ 371 Date: Jul. 31, 2017

(30) Foreign Application Priority Data
Jan. 30, 2015 (CN) 201510054882.4

(51) Int. Cl. H04L 5/00; H04B 7/06; H04W 72/04

(52) U.S. Cl. CPC H04L 5/0057; H04L 5/0048; H04B 7/0626; H04W 72/0446; H04W 72/0453; H04W 72/0413

(57) ABSTRACT

A method is described for reporting CSI by UE, including: UE determining a CSI reference resource and reporting CSI on the CSI reference resource, herein the CSI reference resource is one or more subframes in a time domain and one or more narrowbands in a frequency domain. Also described is a method for triggering UE to report CSI, including: a network side sending the following contents to UE: a reference signal, related resource information about periodically reporting and/or related resource information about triggering report.

### CROSS-REFERENCE TO RELATED APPLICATION

This application is the U.S. national phase of PCT Application No. PCT/CN2016/071976 filed Jan. 25, 2016, which claims priority to Chinese Application No. 201510054882.4 filed Jan. 30, 2015, the disclosures of which are incorporated in their entirety by reference herein.

### TECHNICAL FIELD

The present application relates to but not limited to the field of wireless communication, in particular to a method and a device for reporting Channel State Information (CSI) by User Equipment (UE) and triggering UE to report CSI.

### BACKGROUND

Machine Type Communication (MTC) User Equipment (UE) is also called as a Machine to Machine (M2M) user communication device, and is a main application form of Internet of Things at present.

In recent years, since the spectrum efficiency of Long-Term Evolution (LTE)/Long-Term Evolution Advance (LTE-Advance or LTE-A) is high, more and more mobile operators select LTE/LTE-A as an evolution direction of broadband wireless communication systems. Various MTC data services based on LTE/LTE-A will become more attractive.

MTC devices usually are low-cost devices and have features such as smaller supported Radio Frequency (RF) bandwidth and single receiving antenna, and RF sending and receiving bandwidth is generally 1.4 MHz. MTC UE can receive signals in six continuous Physical Resource Blocks (PRBs) at most in one subframe.

In the existing CSI reporting mode, average CSI of full-bandwidth on a subframe or CSI of a sub-band selected by UE/configured by a high layer needs to be reported on a report subframe. The CSI includes at least one of the following: Channel Quality Indicator (CQI), Precoding Matrix Indicator (PMI), Precoding Type Indicator (PTI) and Rank Indication (RI). Since the receiving capability of the MTC UE is limited and CSI of more than six PRBs cannot be obtained in one subframe, the CSI reporting mode in the existing technology has already been not applicable to MTC UE any longer and a new CSI reporting mode needs to be defined for MTC UE.

### SUMMARY

What is described below is a summary of the subjected described in detail in this document. This summary is not used for limiting the protection scope of the claims.

The embodiment of the present disclosure provides a method and a device for reporting CSI by UE, such that the UE can report CSI of narrowband resources.

The embodiment of the present disclosure provides a method for reporting CSI by UE, including:

UE determining a CSI reference resource and reporting CSI on the CSI reference resource, herein the CSI reference resource is one or more subframes in a time domain and one or more narrowbands in a frequency domain.

The embodiment of the present disclosure further provides a device for reporting CSI, located in UE, and including a CSI reference resource determination module and a reporting module, herein:

the CSI reference resource determination module is configured to determine a CSI reference resource, herein the CSI reference resource is one or more subframes in a time domain and one or more narrowbands in a frequency domain; and

the reporting module is configured to report CSI on the CSI reference resource.

The embodiment of the present disclosure further provides a method and a device for triggering UE to report CSI, such that the UE can report CSI of narrowband resources.

The embodiment of the present disclosure provides a method for triggering UE to report CSI, including:

a network side sending the following contents to UE: a reference signal, related resource information about periodically reporting and/or related resource information about triggering report.

The embodiment of the present disclosure further provides a device for triggering UE to report CSI, including:

a first sending module configured to send a reference signal to UE; and

a second sending module configured to send the following contents to the UE: related resource information about periodically reporting and/or related resource information about triggering report.

Besides, the embodiment of the present disclosure further provides UE, including a processor and a communication unit. The processor is configured to determine a CSI reference resource, the CSI reference resource is one or more subframes in a time domain and one or more narrowbands in a frequency domain. The communication unit is configured to report the CSI on the CSI reference resource.

Besides, the embodiment of the present disclosure further provides a computer-readable storage medium, storing computer-executable instructions, which, when executed, implement the method for reporting CSI by UE.

Besides, the embodiment of the present disclosure further provides a computer-readable storage medium, storing computer-executable instructions, which, when executed, implement the method for triggering UE to report CSI.

With the methods provided by the embodiments of the present disclosure, the UE can report CSI of narrowbands, and the methods are particularly applicable to user equipment with a limited receiving capability.

Other features and advantages of the present application will be described in the description below, and partially become obvious from the description or can be understood by implementing the present application. The purpose and other advantages of the present application can be realized and obtained through structures specially pointed out in the description, the claims and the drawings.

After the drawings and the detailed description are read and understood, other aspects may be understood.

### BRIEF DESCRIPTION OF DRAWINGS

The drawings are used for providing further understanding about the scheme of the present disclosure, constitute a part of the description and are used together with the embodiments of the present application for explaining the scheme of the present application instead of limiting the scheme of the present application.

FIG. 1 illustrates a flowchart of a method according to embodiment 1 of the present disclosure.

FIG. 2 illustrates a structural schematic diagram of a device according to embodiment 3 of the present disclosure.

FIG. 3 illustrates a structural schematic diagram of a device according to embodiment 4 of the present disclosure.

FIG. 4 illustrates an exemplary diagram in application example 1.

FIG. 5 illustrates an exemplary diagram in application example 2.

FIG. 6 illustrates an exemplary diagram in application example 4.

FIG. 7 illustrates one exemplary diagram in application example 10.

FIG. 8 illustrates another exemplary diagram in application example 10.

### DETAILED DESCRIPTION

The embodiments of the present disclosure will be described below in detail with reference to the drawings. It needs to be stated that the embodiments in the present application and the features in the embodiments may be mutually and freely combined.

The steps illustrated in the flowcharts of the drawings may be executed in a computer system including, for example, a group of computer-executable instructions. In addition, although logic sequences are illustrated in the flowcharts, under some situations, the illustrated or described steps may be executed according to sequences different from the sequences here.

In this document, UE includes UE which is not capable of receiving signals on full bandwidth, and the bandwidth for the UE to receive downlink signals is the narrowband described in this document. The situation that the UE is not capable of receiving signals on full bandwidth includes but not limited to the following: the UE has a capability of receiving signals on full bandwidth but is not capable of receiving signals on full bandwidth since the capability is limited, and the UE does not have a capability of receiving signals on fully bandwidth.

### Embodiment 1

This embodiment describes a method for reporting CSI by UE. In this embodiment, UE reports CSI according to a preset period and the period by which the UE reports CSI may also be configured by a network side. As illustrated in FIG. 1, the method includes the following steps 110 and 120.

In step 110, UE determines a CSI reference resource, herein the CSI reference resource is one or more subframes in a time domain and one or more narrowbands in a frequency domain.

The CSI reference resource may be one of the following a1-a4.

a1. The CSI reference resource is a downlink subframe in the time domain, the downlink subframe is a subframe before a preset subframe, and the CSI reference resource is a narrowband corresponding to the downlink subframe in the frequency domain.

a2. The CSI reference resource is a predesignated narrowband in the frequency domain and is one or more downlink subframes corresponding to the predesignated narrowband in the time domain, and the downlink subframe is a subframe before a preset subframe.

a3. The CSI reference resource is a narrowband different from narrowbands corresponding to CSI reported at previous K times in the frequency domain, where K is a positive integer, K<N and N is a total number of narrowbands which need to be measured. And the CSI reference resource is one or more downlink subframes corresponding to the narrowband in the time domain, and the downlink subframe is a subframe before a preset subframe.

a4. The CSI reference resource is one or more downlink subframes in a time window in the time domain, and is a narrowband corresponding to the one or more downlink subframes in the frequency domain.

In this document, the subframe before the preset subframe contains the preset subframe itself.

In this document, a narrowband for UE to receive a downlink signal on a subframe is called as a narrowband corresponding to the subframe, and a narrowband for UE to receive a downlink signal on a time-domain CSI reference resource is called as a narrowband corresponding to the CSI reference resource. The UE reports the CSI on the CSI reference resource, and the CSI reference resource may also be called as a CSI reference resource corresponding to the reported CSI.

In the a1 and a4, the narrowband corresponding to the downlink subframe may be a preset narrowband and may also be a configured narrowband. In other words, the narrowband which is measured at each time is a predetermined and fixed narrowband. For example, if a network side is configured with a narrowband, the UE receives a downlink signal on the narrowband; and if the network side is configured with multiple narrowbands, the UE may select one narrowband from the multiple narrowbands and receive a downlink signal on the narrowband.

In the a4, the time window may be selected to be before the preset subframe. In an application mode, the narrowband corresponding to partial or all downlink subframes in the time window is a preset or configured narrowband, and the UE receives a downlink signal on the narrowband corresponding to partial or all downlink subframes in the time window. The presetting refers to setting in advance, and the configuring refers to distributing by the network side.

*In an application mode, the CSI reference resource is a subframe for the UE to receive control information and/or downlink data in the time domain, and a narrowband corresponding to the subframe for receiving control information and/or downlink data traverses all available narrowbands within a period of time. The operation that the narrowband where the downlink signal is located traverses all available narrowbands is implemented through the configuration of the network side, i.e., within a period of time, the network side configures that a narrowband for sending downlink signals at each time is different till all available narrowbands have already been configured to send downlink signals. The available narrowbands may be narrowbands which are obtained by dividing system bandwidth in advance, and may also be narrowbands which are configured by an eNB (evolved Node B), such as narrowbands notified in System Information Block (SIB) or Radio Resource Control (RRC) signaling.

*In an application mode, the CSI reference resource is the subframe in the measurement subframe set, the CSI reference resource is a first narrowband which is preset or notified by an eNB in the frequency domain, and the UE receives a downlink signal on the subframe in the measurement subframe set and on the first narrowband. In an application mode, if a narrowband for receiving a control signal and/or downlink data is not overlapped with the first narrowband on the subframe in the measurement subframe set, the UE gives up receiving the control signal and/or data signal, and only receives a downlink signal on the subframe in the measurement subframe set and on the first narrowband.

*In an application mode, the subframe of the CSI reference resource in the time domain is an effective downlink subframe. The effective downlink subframe satisfies at least one of the following conditions:

the subframe is a downlink subframe;

the subframe is not a Multicast Broadcast Single Frequency Network MBSFN subframe except in a transmission mode 9 or a transmission mode 10;

the subframe does not contain a Downlink Pilot Time Slot (DwPTS) with a length less than or equal to 7680·Tₛ, where Tₛ is a time unit such as Tₛ=1/(15000*2048) second;

the subframe is not within a configured measurement gap; and

if the UE is configured with a CSI subframe set, the subframe is a subframe in the CSI subframe set.

*In an application mode, the time-domain CSI reference resource is one or more downlink subframes closest to a report subframe in subframes before a preset subframe. Alternatively, the downlink subframe is, for example, the effective downlink subframe described above.

*A CSI-Reference Signal (CSI-RS) on one subframe in one or more subframes of the CSI reference resource in the time domain does not exceed a bandwidth corresponding to the subframe in the frequency domain.

In step 120, the UE reports CSI on the CSI reference resource.

*In addition to CQI, the contents of the CSI reported by the UE may further include at least one of the following information: Precoding Matrix Indicator (PMI) on the CSI reference resource, Precoding Type Indicator (PTI) on the CSI reference resource and Rank Indication (RI) on the CSI reference resource. The CQI in the CSI reported by the UE may be an absolute value and/or relative value. Reporting the CSI on the CSI reference resource specifically includes one of the following:

b1. reporting a Channel Quality Indicator (CQI) on the CSI reference resource;

b2. reporting a narrowband index and a CQI of a narrowband corresponding to the narrowband index, herein the CQI of the narrowband corresponding to the narrowband index includes at least one of the following: a CQI on the first bandwidth; and a CQI of each narrowband corresponding to the narrowband index, herein, the first bandwidth consists of all narrowbands corresponding to the narrowband indexes;

b3. reporting a subframe index and a CQI of a narrowband corresponding to the subframe index, herein the CQI of the narrowband corresponding to the subframe index include at least one of the following: a CQI on the second bandwidth; and a CQI of each narrowband corresponding to the subframe index, herein the second bandwidth consists of all narrowbands corresponding to the subframe indexes;

b4. reporting CQIs of narrowbands arranged according to a preset sequence in the frequency domain; and

b5. reporting a CQI of a narrowband corresponding to each subframe contained in the CSI reference resource, herein the CQIs of the narrowbands are arranged according to a preset sequence.

*In an application mode, the UE reports the CSI through a Physical Uplink Control Channel (PUCCH) or a Physical Uplink Shared Channel (PUSCH).The PUSCH resource is preset.

### Embodiment 2

This embodiment describes a method for reporting CSI by UE. In this embodiment, the UE reports CSI after receiving information about triggering CSI report. The information about triggering CSI report may be contained in Downlink Control Information (DCI) or a Random Access Response (RAR). The DCI is DCI for scheduling a Physical Uplink Shared Channel (PUSCH) or DCI for scheduling a Physical Downlink Shared Channel (PDSCH) or dedicated DCI. The RAR is an RAR during contention-free access or an RAR during contention access.

The method for reporting CSI by UE provided by this embodiment includes the following steps 210 and 220.

In step 210, UE determines a CSI reference resource, wherein the CSI reference resource is one or more subframes in a time domain and one or more narrowbands in a frequency domain.

The CSI reference resource may be one of the following c1-c4.

c1. The CSI reference resource is a downlink subframe for receiving the DCI in the time domain and is a narrowband corresponding to the downlink subframe in the time domain.

c2. The CSI reference resource is a downlink subframe where a PDSCH scheduled through the DCI is located in the time domain, and is a narrowband corresponding to the downlink subframe in the frequency domain.

c3. The CSI reference resource is one or more downlink subframes in a time window in the time domain and is a narrowband corresponding to the downlink subframe(s) in the frequency domain.

c4. The CSI reference resource includes a resource indicated in the DCI or RAR.

In c3, the narrowband corresponding to the downlink subframe(s) may be a preset narrowband and may also be a configured narrowband. In an application mode, the narrowband corresponding to partial or all downlink subframes in the time window is a preset or configured narrowband, and the UE receives a downlink signal on the narrowband corresponding to partial or all downlink subframes in the time window.

In step 220, the UE reports CSI on the CSI reference resource.

The subframe for the UE to report the CSI is one of the following:

d1. a subframe scheduled through first DCI or RAR for sending the PUSCH, herein the first DCI is DCI containing information about triggering CSI report and the UE reports the CSI according to the information about triggering CSI report;

d2. a subframe scheduled through second DCI for sending the PUSCH, herein previous DCI of the second DCI is DCI containing information about triggering CSI report and the UE reports the CSI according to the information about triggering CSI report; and

d3. an (n+k)th subframe, where n is a subframe where the DCI or RAR containing information about triggering CSI report is located and k is a positive integer greater than 0 and not less than a preset value.

In embodiment 1, features marked with “*” are also applicable to embodiment 2.

### Embodiment 3

This embodiment describes a device for reporting CSI, located in UE, and as illustrated in FIG. 2, including a CSI reference resource determination module and a reporting module.

The CSI reference resource determination module is configured to determine a CSI reference resource, wherein the CSI reference resource is one or more subframes in a time domain and one or more narrowbands in a frequency domain.

The reporting module is configured to report CSI on the CSI reference resource.

In an application mode, the reporting module is configured to: periodically report the CSI on the CSI reference resource; or report the CSI on the CSI reference resource after receiving information about triggering CSI report.

In an application mode, the information about triggering CSI report is contained in DCI or an RAR. Alternatively, the DCI is DCI for scheduling a Physical Uplink Shared Channel (PUSCH) or DCI for scheduling a Physical Downlink Shared Channel (PDSCH) or dedicated DCI.

In an application mode, when the reporting module is configured to periodically report the CSI on the CSI reference resource, for the CSI reference resource determined by the CSI reference resource determination module, refer to embodiment 1.

In an application mode, when the reporting module is configured to report the CSI on the CSI reference resource after receiving the information about triggering CSI report, the information about triggering CSI report is contained in Downlink Control Information (DCI) or a Random Access Response (RAR), the CSI reference resource determination module determines the CSI reference resource, and for the subframes where the reporting module reports the CSI on the CSI reference resource at this moment, refer to embodiment 2.

For the contents reported by the reporting module, refer to the description in embodiment 1.

In an application mode, the CSI reference resource determination module is configured to determine that the CSI reference resource is a subframe for the UE to receive control information and/or downlink data in the time domain, or a subframe in a measurement subframe set. For details, refer to the description in embodiment 1.

In an application mode, the subframe of the CSI reference resource determined by the CSI reference resource determination module in the time domain is an effective downlink subframe. For conditions which are satisfied by the effective downlink subframe, refer to the description in embodiment 1.

In an application mode, the time-domain CSI reference resource determined by the CSI reference resource determination module is one or more downlink subframes closest to a report subframe in subframes before a preset subframe.

In an application mode, a CSI-Reference Signal (CSI-RS) on one subframe in one or more subframes of the CSI reference resource determined by the CSI reference resource determination module in the time domain does not exceed a bandwidth corresponding to the subframe in the frequency domain.

The device in this embodiment is a device for implementing the method in embodiment 1 and the method in embodiment 2. For other implementation details, refer to the description in embodiment 1 and embodiment 2 above.

### Embodiment 4

In this embodiment, a network side triggers UE to report CSI by the following mode:

a network side sending the following contents to UE: a reference signal, related resource information about periodically reporting and/or related resource information about triggering report.

The reference signal is used for performing channel measurement and includes a Cell Reference Signal (CRS) and/or a CSI-Reference Signal (CSI-RS). Alternatively, the bandwidth of the CSI-RS in a frequency domain does not exceed bandwidth of a narrowband for sending a downlink signal to the UE.

The related resource information about periodically reporting includes at least one of the following information:

report period and/or subframe offset, herein the report period and/or the subframe offset may also be preset;

resource used for reporting CSI, herein, for example, when the UE reports CSI through a PUCCH, a report resource for sending by the network side is a PUCCH resource, and if the UE reports CSI through a PUSCH, a report resource is a PUSCH resource;

time window information, herein the time window information may also be preset;

measurement subframe set, herein the network side sends a downlink signal on a subframe in the measurement subframe set and on a fixed narrowband;

frequency-domain CSI reference resource, such as the narrowband corresponding to the downlink subframe(s) in a1 or a4 in embodiment 1 and the narrowband corresponding to the downlink subframe(s) in c3 in embodiment 2; and

available narrowband.

The related resource information about triggering report includes at least one of the following information:

information about triggering CSI report;

resource used for reporting CSI, such as a PUCCH resource or a PUSCH resource;

time window information;

measurement subframe set;

time-domain CSI reference resource; and

frequency-domain C SI reference resource.

In an application mode, the related resource information about triggering report is contained in Downlink Control Information (DCI) or a Random Access Response (RAR). The DCI is DCI for scheduling a PUSCH or DCI for scheduling a PDSCH or dedicated DCI. In an application mode, the PUSCH resource is preset. The RAR is an RAR during contention-free access or an RAR during contention access.

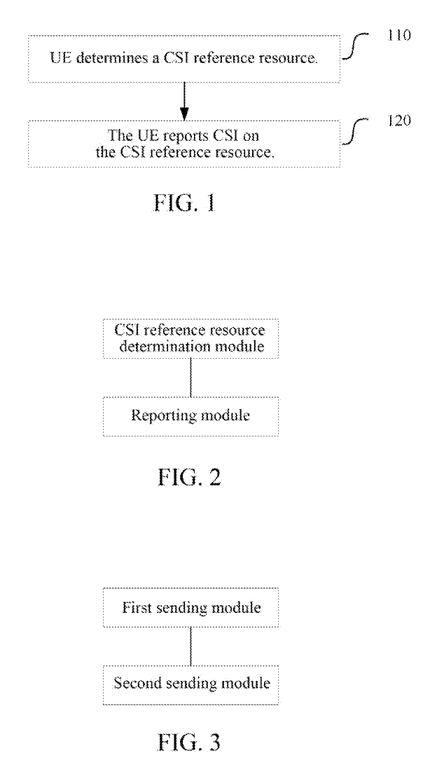

A device for triggering UE to report CSI for implementing the above-mentioned method, as illustrated in FIG. 3, includes a first sending module and a second sending module.

The first sending module is configured to send a reference signal to UE.

The second sending module is configured to send the following contents to the UE: related resource information about periodically reporting and/or related resource information about triggering report.

In an application mode, the reference signal includes a Cell Reference Signal (CRS) and/or a CSI-Reference Signal (CSI-RS). In an application mode, the bandwidth of the CSI-RS in a frequency domain does not exceed a bandwidth of a narrowband for sending a downlink signal to the UE.

In an application mode, the second sending module is configured to contain the related resource information about triggering report into DCI or an RAR for sending.

For other implementation details, refer to the description above.

In the existing mode, the CSI reference resource is a subframe in the time domain and is determined in the frequency domain by the reporting mode configured by the eNB, such as reporting CQIs on the full bandwidth or reporting CQIs of one or more selected sub-bands or all sub-bands. The sub-bands are sub-bands divided by the eNB, the magnitude of each sub-band is related to the system bandwidth. Under a situation that CQIs of multiple sub-bands instead of all sub-bands are reported, the number of reported sub-bands is also determined by the system bandwidth. For MTC UE, the receiving capability thereof is limited and a broadband CQI cannot be obtained on one subframe. For CQIs of sub-bands, UE cannot measure multiple sub-bands and select out one or more the best sub-bands. For system bandwidth which is 20 MHz, the magnitude of each sub-band is eight PRBs and MTC UE cannot receive one sub-band. By using the methods provided by the embodiments of the present disclosure, since the UE measures the narrowband on one or more subframes, the problem that MTC UE cannot report the CSI is solved and the effect is better for MTC UE which supports small RF bandwidth. However, the methods provided the embodiments of the present disclosure are not limited to be applicable to MTC UE, and other UE may also report CSI by referring to the methods provided by the embodiments of the present disclosure.

The method in the above-mentioned embodiments will be specifically described below through multiple application examples. In the following examples, example 1 to example 4 are examples that UE reports CSI according to a preset period, and a difference lies in that CSI reference resources are different. Example 5 to example 9 are examples that UE reports CSI according to trigger information, and a difference lies in that CSI reference resources are different and reporting modes are different. Example 10 is an example of contents contained in CSI reported by UE. The examples may be mutually combined. For example, example 10 may be combined with other examples. Features in the examples may also be mutually combined. For example, the feature that “the time-domain CSI reference resource is an effective downlink subframe” and the definition of the effective subframe in example 1 may also be applicable to other examples. For another example, the reported contents, in addition to CQIs on the CSI reference resource, may further include at least one of the following contents: PMI, RI, PTI on the CSI reference resource, which are also applicable to other examples. For another example, a measurement subframe set may be configured in all of the examples. There are other combinations, which are not described here one by one. One skilled in the art should know according to the concept of the present application and the contents in the prior art.

### APPLICATION EXAMPLE 1

In this example, UE periodically reports CSI. A sending period and a subframe offset of CSI may be preset and may also be notified by an eNB (Evolved NodeB).

UE determines a CSI reference resource, performs CSI measurement on the CSI reference resource and determines to report CSI (which includes CQI and may alternatively include at least one of the following: PMI, PTI and RI) on the CSI reference resource on a subframe n according to the sending period and the subframe offset.

The CSI reference resource includes a time-domain resource (or called as a time-domain CSI reference resource) and a frequency-domain resource (or called as a frequency-domain CSI reference resource). In this example, the CSI reference resource is a downlink subframe in a time domain, and the downlink subframe is a subframe before a preset subframe, and is a narrowband corresponding to the time-domain CSI reference resource in a frequency domain. The preset subframe is a (n−k)th subframe, where n is a subframe for the UE to report the CSI and k is a preset value such as an integer not less than 4. In an implementation mode, k=4, the subframes before the preset subframe include n−4, n−5, n−6 . . . . The narrowband corresponding to the time-domain CSI reference resource is a narrowband for the UE to receive a downlink signal on the preset downlink subframe.

In one example, the time-domain CSI reference resource may be a subframe for receiving downlink control information and/or downlink data information. On the subframe, the frequency-domain CSI reference resource is a narrowband where the downlink control information and/or downlink data information is located. The narrowband may be preset. For example, it is preset that the narrowband for the UE to receive the downlink control information is a narrowband formed by continuous M PRBs, where M is a maximum number of continuous PRBs supported by the UE, and alternatively, M=6. The narrowband may also be obtained according to a preset rule. For example, one the subframe corresponding to the time-domain CSI reference resource, the UE only receive PDSCH on PRBs #5 and #7, and at this moment, the preset frequency-domain CSI reference resource of the UE is a narrowband formed by M PRBs starting from a start PRB, i.e., PRBs #5 to #10. In actual application, the mode is not limited thereto as long as it is a narrowband containing PRBs where PDSCH is located.

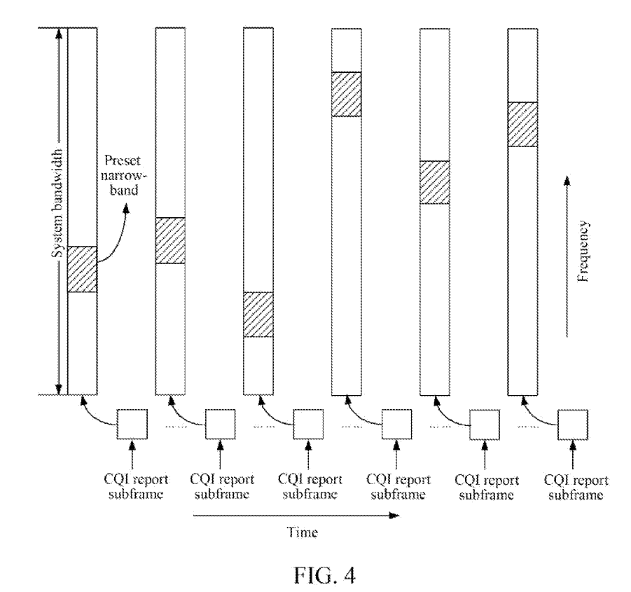

In this example, the frequency-domain CSI reference resource (i.e., a narrowband corresponding to the downlink subframe in the time domain) may be a preset or configured narrowband, and the UE receives a downlink signal on the preset or configured narrowband. In FIG. 4, the CQI reported by the UE on a CQI report subframe is a CQI of the preset narrowband in FIG. 4. As illustrated in FIG. 4, the preset narrowband hops on the full bandwidth.

In one example, a narrowband for receiving the control information and/or the data information traverses all available narrowbands within a period of time. Traversing all available narrowbands refers to that an available narrowband is used for receiving a downlink signal at each time within a period of time till all available narrowbands are completely used. The available narrowbands may be narrowbands obtained by dividing system bandwidth in advance, and may also be narrowbands configured by the eNB, such as narrowbands notified in SIB or RRC signaling.

In one example, the time-domain CSI reference resource is one or more downlink subframes closest to a report subframe in subframes before a preset subframe. For example, the report subframe is n, the subframes before the preset subframe include n−4, n−5 and n−6, and thus the time-domain CSI reference resource is subframe #n−4

In one example, the time-domain CSI reference resource is an effective downlink subframe. The effective downlink subframe is a subframe which satisfies at least one of the following conditions:

1) the subframe is a downlink subframe;

2) the subframe is not a Multicast Broadcast Single Frequency Network (MBSFN) subframe except in a transmission mode 9 or a transmission mode 10;

3) the subframe does not contain a Downlink Pilot Time Slot (DwPTS) with a length less than or equal to 7680·Tₛ, where Tₛ is a time unit such as Tₛ=1/(15000*2048) second;

4) the subframe is not within a configured measurement gap; and

5) if the UE is configured with a CSI subframe set (configured by a high layer), the subframe is a subframe in the CSI subframe set.

For example, supposing that the report subframe is n, the subframes before the preset subframe include n−4, n−5 and n−6, the effective downlink subframe closest to the report subframe is n-6 and thus the time-domain CSI reference resource is subframe #n−6.

In one example, the CSI reference resource corresponding to the CSI reported by the UE is a subframe (measurement subframe) in a measurement subframe set in the time domain. The measurement subframe set is predefined or notified by the eNB, the subframes in the measurement subframe set may be continuous and may also be non-continuous, and on the subframe in the measurement subframe set, the UE receives a downlink signal (including control information and/or data information) on the narrowband preset or notified by the eNB according to a preset pattern. The narrowband may traverse the entire system bandwidth or configured narrowbands in time.

In an implementation mode, the UE may further select a downlink subframe closest to the report subframe from the measurement subframe set before the preset subframe as the time-domain CSI reference resource.

In one example, the preset narrowband on the measurement subframe is a narrowband divided in advance on each type of system bandwidth, or is a narrowband configured by the eNB, such as a narrowband notified in SIB or RRC signaling. For example, the eNB notifies the UE of four available narrowbands in SIB, which are respectively narrowbands #0, #1, #2 and #3. In an implementation mode, the subframes in the measurement subframe set may be some fixed subframes, e.g., the eNB notifies the UE that the measurement subframe set includes subframe #0 on each frame and a measurement narrowband index is n_{frame} mod N, where “mod” represents a modulo operation, n_{frame} is a frame number and N is a total number of narrowbands such as N=17 for a 20 MHz system. The measurement subframe sets notified by the eNB to different UEs and the receiving narrowbands on the measurement subframe set may be different.

In one example, if a narrowband for the UE to receive a control signal and/or a data signal is not overlapped with the preset or notified narrowband on the subframe in the measurement subframe set, receiving the control signal and/or the data signal is given up. For example, if subframe #1 is a measurement subframe, the preset narrowband on the measurement subframe is narrowband #5, and before the subframe #1, the eNB schedules the UE to receive PDSCH on the narrowband #1 on the subframe #1, the UE receives a downlink signal on the narrowband #5 on the subframe #1 and gives up receiving the PDSCH on the narrowband #1.

### APPLICATION EXAMPLE 2

A difference between this example and example 1 lies in that the CSI reference resource corresponding to the CSI reported by the UE is a predesignated narrowband in the frequency domain, the designated narrowband is a narrowband in a narrowband set. For example, a narrowband set is predefined for each type of system bandwidth or the eNB configures a narrowband for the UE, the UE reports CSI of one narrowband in the narrowband set on each report subframe. The designated narrowband corresponding to the CSI reported on each report subframe is preset or the designated narrowband corresponding to the CSI reported on the report subframe is arranged according to a preset sequence. For example, there are four narrowbands in the narrowband set, indexes of the narrowbands are respectively 0, 1, 2 and 3, and the UE reports the CSI on the narrowband according to the sequence of 0, 1, 2 and 3.

The difference between this example and example 1 further lies in that the CSI reference resource corresponding to the CSI reported by the UE is one or more subframes corresponding to the frequency-domain CSI reference resource in the time domain. The one or more subframes are subframes before a preset subframe, for example, the preset subframe is a (n−k)th subframe, where k is a preset value such as an integer not less than 4, and optionally k=4. On the time-domain CSI reference resource, i.e., the one or more subframes, the UE receives a downlink signal on the frequency-domain CSI reference resource.

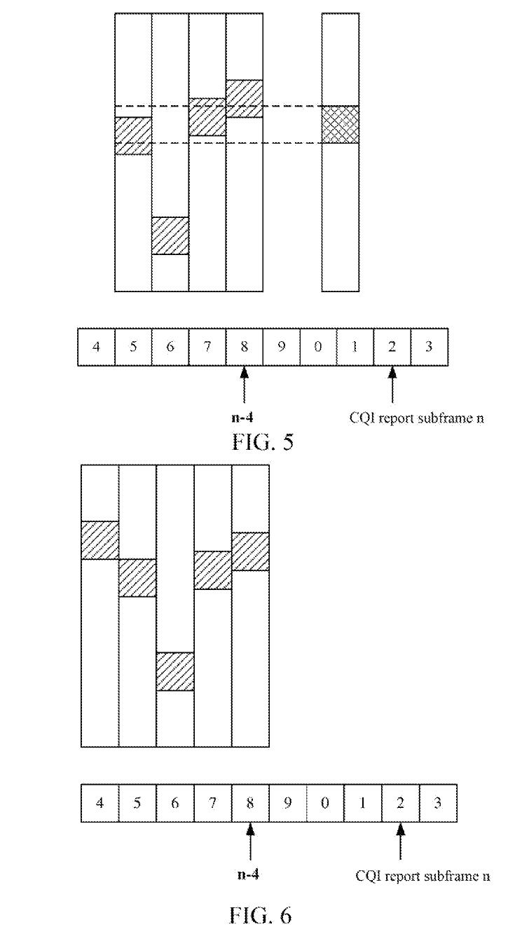

When the frequency-domain CSI reference resource, i.e., the predesignated narrow, is not exactly a narrowband for the UE to receive the downlink signal, i.e., narrowbands for the UE to receive the downlink signal on multiple subframes jointly cover the predesignated narrowband, the frequency-domain CSI reference resource is the multiple subframes. As illustrated in FIG. 5, subframe #2 is a subframe for reporting CSI, the preset subframe is a (n−4)th subframe, i.e., subframe #8. What is illustrated by a latticed area in FIG. 5 is the frequency-domain CSI reference resource, the narrowband for the UE to receive the downlink signal is as illustrated by an oblique line part. The narrowbands for the UE to receive the downlink signal on subframes #5, #7 and #8 cover the latticed area, and thus the time-domain CSI reference resource is subframes #5, #7 and #8. At this moment, the CQI reported by the UE may be an average CQI of all narrowbands on these subframes and may also be an average CQI of only PRBs which belong to the present narrowband in the narrowbands on these subframes. For specific reported contents, refer to example 10.

The CSI reference resource corresponding to the CSI reported by the UE may also be a subframe in the measurement subframe set in the time domain and a narrowband corresponding to the subframe is the predesignated narrowband. For various application modes of the measurement subframe set, refer to example 1. This example may be combined with various application modes related to the measurement subframe set in example 1.

### APPLICATION EXAMPLE 3

A difference between this example and example 2 lies in that the CSI reference resource corresponding to the CSI reported by the UE is a narrowband different from narrowbands corresponding to CSI reported at previous K times in the frequency domain. The narrowband corresponding to the CSI refers to a narrowband in the CSI reference resource corresponding to the CSI, where K is a positive integer, K<N, N is a total number of narrowbands in the narrowband set, and optionally, K=N−1. Under this situation, when the UE reports the CSI on the CSI reference resource, the UE further needs to report a narrowband index corresponding to the narrowband, such that the eNB acquires the narrowband information corresponding to the reported CSI.

The CSI reference resource corresponding to the CSI reported by the UE may be a subframe for receiving downlink control information and/or downlink data information in the time domain, or may also be a subframe in a measurement subframe set. The measurement subframe set is predefined or notified by the eNB. On the subframe in the measurement subframe set, the UE receives on the preset or notified narrowband. In this example, the base station may be configured with a measurement subframe set. For various application modes of the measurement subframe set, refer to example 1. This example may be combined with various application modes related to the measurement subframe set in example 1.

If the time-domain CSI reference resource is the subframe for receiving the downlink control information and/or downlink data information, optionally, a subframe for receiving a downlink signal closest to a report subframe is set as the time-domain CSI reference resource.

### APPLICATION EXAMPLE 4

A difference between this example and example 1 lies in that the time-domain CSI reference resource is one or more downlink subframes in a time window, and the frequency-domain CSI reference resource is a narrowband for the UE to receive a downlink signal on the subframe corresponding to the time-domain CSI reference resource, i.e., a narrowband corresponding to the downlink subframe of the time-domain CSI reference resource.

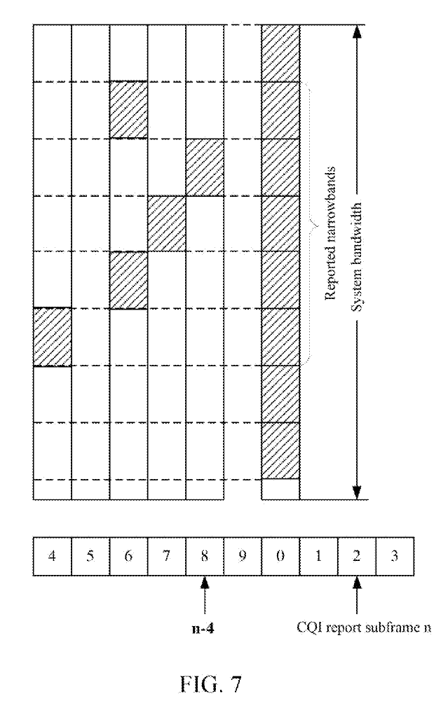

The size of the time window is preset or notified by the eNB, e.g., is 5 ms or 10 ms notified by the eNB. The start or end position of the time window may also be preset. Alternatively, the time window is multiple subframes before a preset subframe (the definition of the preset subframe is as the same as that in example 1), such as five subframes. As illustrated in FIG. 6, the time window is subframes #4 to #8.

In an implementation mode, the narrowband corresponding to the downlink subframe of the time-domain CSI reference resource may be preset and may also be configured by a network side.

In an implementation mode, the narrowband corresponding to partial or all downlink subframes in the time window is a preset or configured narrowband. The UE receives a downlink signal on the narrowband corresponding to partial or all downlink subframes in the time window.

In an implementation mode, the UE receives a downlink signal on a fixed narrowband in the time window.

In this example, the base station may configure a measurement subframe set. For various application modes of the measurement subframe set, refer to example 1. This example may be combined with various application modes related to the measurement subframe set in example 1.

### APPLICATION EXAMPLE 5

In this example, the UE reports the CSI on the CSI reference resource after receiving information about triggering CSI report. The UE receives CSI report request information sent by the eNB, the CSI report request information is contained in DCI or an RAR, and the UE reports the CSI on a designated subframe.

The RAR may be an RAR during contention-free access and may also be RAR during contention access.

A CSI reporting mode of the UE includes the follow:

The UE receives DCI for triggering CSI report on an nth subframe. In this embodiment, the DCI is DCI for scheduling a PUSCH. After the UE receives the DCI, the UE reports a CQI on a (n+k)th subframe on the scheduled PUSCH. In an implementation mode, the subframe for reporting the CSI is a subframe capable of reporting closest to a subframe where the DCI is located. In an LTE FDD (Frequency Division Dual) system, k=4. The time-domain CSI reference resource is subframe #n, and the frequency-domain reference resource is a narrowband corresponding to subframe #n.

### APPLICATION EXAMPLE 6

In this example, the UE receives DCI for triggering CSI report on an nth subframe and the DCI is DCI for scheduling a first PUSCH. After the UE receives the DCI, the UE does not report a CQI on a subframe for sending the first PUSCH but reports a CQI on a subframe for sending a second PUSCH after receiving DCI for scheduling a next PUSCH, i.e., a second PUSCH. The next DCI may also be DCI containing information about triggering CSI report.

In this example, the CSI reference resource for the UE to report the CSI is all or partial subframes in a time window in a time domain. For example, the time window is subframes between subframes where the two pieces of DCI are located. The time-domain CSI reference resource is one or more subframes or all subframes in the time window, and the frequency-domain CSI reference resource is a narrowband corresponding to the CSI reference resource. The time window may be preset or configured by a network side.

In an implementation mode, a narrowband corresponding to partial or all downlink subframes in the time window is a preset or configured narrowband, and the UE receives a downlink signal on the narrowband corresponding to partial or all downlink subframes in the time window.

In an implementation mode, the UE receives a downlink signal on a preset narrowband in the time window.

In an implementation mode, in this example, a measurement subframe set may also be configured. For the concept and related features of the measurement subframe set, refer to the description in example 1.

In one example, the DCI may further contain CSI reference resource information, i.e., narrowband information and/or subframe information. For example, the DCI contains a narrowband index or a subframe index; or the DCI contains a narrowband index and a subframe offset, and the UE determines a receiving and measurement subframe according to the subframe offset and performs receiving and measurement on the narrowband on the subframe; or the DCI may also contain multiple narrowband indexes to indicate that the UE performs receiving and measurement on several narrowbands respectively on several subsequent subframes; or the DCI may also contain several subframe indexes. The subframe indicated in the DCI is a subframe in the time window. In other examples, the RAR may also contain CSI reference resource information. The application mode that the DCI or the RAR contains the CSI reference resource information may be combined with the features of other application examples.

### APPLICATION EXAMPLE 7

In the example, the UE receives DCI or an RAR for triggering CSI report on an nth subframe, and the DCI is DCI for scheduling PDSCH receiving or PUSCH sending, or dedicated DCI. The RAR may be an RAR during contention-free access and may also be an RAR during contention access. Then, the UE reports the CSI on a preset subframe, and there may be a fixed relation between the report subframe and the subframe for triggering CSI report. For example, the subframe for triggering CSI report is n and the report subframe is n+k, where k is a number not less than a preset value.

The CSI reference resource is subframes in a time window in the time domain, the number of the subframes contained in the time window is not less than 1. For example, the time window is within an interval between the subframe where the DCI or RAR for triggering CSI report is located and the report subframe. All subframes or partial subframes or one subframe in the time window are the time-domain CSI reference resource, and the frequency-domain reference resource is a narrowband corresponding to the time-domain reference resource. Alternatively, the time window is [m, n−k], where m is a subframe for triggering CSI report, n is a report subframe and k is a preset value and is an integer not less than 4. Alternatively, the narrowband corresponding to partial or all downlink subframes in the time window is a preset or configured narrowband, and the UE receives a downlink signal on the narrowband corresponding to partial or all downlink subframes in the time window.

In an implementation mode, the time-domain CSI reference resource may be a subframe for receiving downlink control information and/or downlink data information, or a subframe in a measurement subframe set. The measurement subframe set may be defined as K subframes after the subframe where the DCI or RAR for triggering CSI report is located (including a subframe where the DCI or RAR is located). On the subframe corresponding to the measurement subframe set, the UE performs receiving on the preset or notified narrowband. For various application modes of the measurement subframe set, refer to example 1. This example may be combined with various application modes related to the measurement subframe set in example 1.

The time-domain CSI reference resource is an effective downlink subframe in the time window. The definition of the effective downlink subframe is as described in example 1.

A channel for the UE to report the CSI may be a PUCCH. When the report subframe exactly has a PUSCH which needs to be sent, it may also be the PUSCH, or it may also be specified that the CSI is transmitted on the PUSCH. If the CSI is transmitted by using the PUSCH, the PUSCH resource may be preset or notified.

### APPLICATION EXAMPLE 8

The UE receives DCI for triggering CSI report on an nth subframe and the DCI is DCI for scheduling the UE to receive a PDSCH on a (n+k)th subframe, wherein k is a number not less than 1, and alternatively, k=1. In this example, the CSI reference resource is the (n+k)th subframe in the time domain and is a narrowband for receiving the PDSCH in the frequency domain. The UE, after measurement, reports the CSI on a preset subframe, and there may be a fixed relation between the report subframe and the subframe for triggering CSI report. For example, the subframe for triggering CSI report is n and the report subframe is n+m, where m is a number not less than a preset value.

A channel for the UE to report the CSI may be a PUCCH. When the report subframe exactly has a PUSCH which needs to be sent, it may also be the PUSCH, or it may also be specified that the CSI is transmitted on the PUSCH. If the CSI is transmitted by using the PUSCH, the PUSCH resource may be preset or notified.

In this example, the base station may also configure a measurement subframe set. For various application modes of the measurement subframe set, refer to example 1. This example may be combined with various application modes related to the measurement subframe set in example 1.

### APPLICATION EXAMPLE 9

The UE receives an RAR for triggering CSI report on an nth subframe, the RAR contains an uplink scheduling grant for scheduling the UE to send a message 3 on a (n+k)th subframe. The CSI reported by the UE is contained in the message 3, where k is a preset value such as k=6. The time-domain CSI reference resource is a preset subframe such as subframe #n+k−4, and the frequency-domain reference resource is a preset narrowband. The RAR may further contain a CSI reference resource.

In an implementation mode, the time-domain CSI reference resource may be a subframe for receiving downlink control information and/or downlink data information, or a subframe in a measurement subframe set. The measurement subframe set may be defined as a subframe where the DCI or RAR for triggering CSI report is located and K subframes thereafter. On the subframe corresponding to the measurement subframe set, the UE performs receiving on a preset or notified narrowband. For various application modes of the measurement subframe set, refer to example 1. This example may be combined with various application modes related to the measurement subframe set in example 1.

A channel for the UE to report is a PUCCH. When the report subframe exactly has a PUSCH which needs to be sent, it may be sent together with the PUSCH or it is still sent on the PUCCH.

### APPLICATION EXAMPLE 10

This example describes that the CSI reported by the UE includes one of the following contents:

a) reporting a CQI on all CSI reference resources. Alternatively, the CQI may be an average CQI, e.g., if the frequency-domain CSI reference resource is four narrowbands, an average CQI is calculated on these four narrowbands.

b) reporting narrowband indexes and CQIs of narrowbands corresponding to the narrowband indexes. Alternatively, the CQIs of the narrowbands corresponding to the narrowband indexes include one of the following: CQIs on first bandwidth and CQI of each narrowband corresponding to the narrowband index, herein the first bandwidth consists of all narrowbands corresponding to the narrowband indexes.

The number m of the reported narrowbands may be a fixed value which is preset or notified by the eNB, or 1≦m≦M, where M is preset or notified by the eNB.

The narrowbands in the system bandwidth and the indexes may be predefined or preset, e.g., each type of system bandwidth is divided into multiple narrowbands in advance, which are numbered as 0, 1, 2 . . . from zero according to frequency from low to high. Or the narrowbands in the system bandwidth are configured by the eNB, e.g., are notified in SIB or RRC signaling, and the notified narrowbands are numbered as 0, 1, 2 . . . according to a certain sequence. The narrowband indexes may consist of an index of each reported narrowband. For example, 20 MHz system bandwidth totally is divided into sixteen narrowbands in advance, each narrowband is represented by using a 4-bit binary number, the narrowbands reported by the UE are narrowband #5 and #6, and thus the narrowband indexes are “0101” and “0110”. Or the narrowband indexes may also consist of a unified index of all reported narrowbands. For example, narrowbands #5 and #6 are represented by using a unique number r; or the narrowband indexes may be a bitmap, and the bit number of the bitmap may be the same as the total number of the narrowbands.

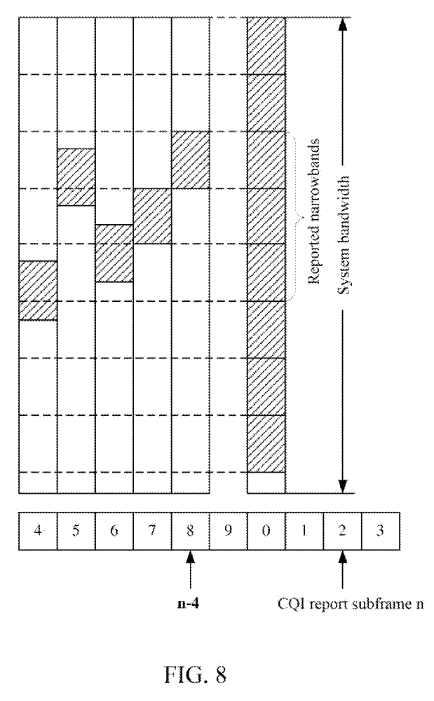

The CQI of the narrowband corresponding to the narrowband index may be a CQI on a narrowband corresponding to a subframe and may also be a CQI of a narrowband corresponding to multiple subframes. On each subframe in the multiple subframes, the narrowband for the UE to receive a downlink signal always contains a part of the narrowband corresponding to the narrowband index. FIG. 7 and FIG. 8 give two examples, herein the system bandwidth is 10 MHz and is divided into eight narrowbands, and the last two RBs (Resource Blocks) are not divided into the narrowbands. In FIG. 7, the time-domain CSI reference resource is subframes #4 to #8, the frequency-domain CSI reference resource is aligned to the divided narrowbands of the system bandwidth, and CQIs of five narrowbands need to be reported. In FIG. 8, the time-domain CSI reference resource is also subframes #4 to #8, the narrowband division is the same as that in FIG. 7, but the frequency-domain CSI reference resource is not aligned to the divided narrowbands of the system bandwidth and corresponds to three narrowbands in the system bandwidth, and CQIs of the three narrowbands need to be reported.

c) reporting subframe indexes and CQIs of narrowbands corresponding to the subframe indexes. Alternatively, the CQIs of the narrowbands corresponding to the subframe indexes include at least one of the following: CQIs on second bandwidth and CQI of each narrowband corresponding to the subframe index. Herein the second bandwidth consists of all narrowbands corresponding to the subframe indexes.

The number k of the reported subframes may be a fixed value which is preset or notified by the eNB, or 1≦k≦K, where K is preset or notified by the eNB. The indexes of the k subframes may consist of an index of each reported subframe, may also be a unified index corresponding to a decimal number and may also be a bitmap. If the time-domain CSI reference resource is a time window, the bit number of the bitmap may be the same as the length of the time window. The CQI may be an average CQI on the narrowbands corresponding to the k subframes, and may also consist of a CQI of a narrowband corresponding to each subframe.

d) reporting CQIs of narrowbands arranged according to a preset sequence in the frequency domain.

The CQIs may consist of CQIs of all narrowbands, e.g., the narrowbands in the system bandwidth and the indexes may be predefined or preset, e.g., each type of system bandwidth is divided into multiple narrowbands in advance, which are numbered as 0, 1, 2 . . . from zero according to frequency from low to high. Or the narrowbands in the system bandwidth are configured by the eNB, e.g., are notified in SIB or RRC signaling, and the notified narrowbands are numbered as 0, 1, 2 . . . according to a certain sequence. If the UE has narrowbands which are not measured, when the CQIs are reported according to a frequency-domain narrowband sequence, a preset value is used to represent the CQI of the narrowband which is not measured, e.g., a CQI index 0 is used for representation. For example, the subframes in the time window totally correspond to five narrowbands but the number of the frequency-domain CSI reference resources of the UE is only two, i.e., the UE only measures CQIs of two narrowbands, when the CQIs of the narrowbands are reported according to the sequence, the reported contents, for example, may be CQI1, CQI2, 0000, 0000, 0000. Herein three “0000” represent three narrowbands which are not measured in the time window. Similar as (b), the CQI of the narrowband may be a CQI on a narrowband corresponding to a subframe and may also be a CQI of a narrowband corresponding to multiple narrowbands. On each subframe in the multiple subframes, the narrowband for the UE to receive a downlink signal always contains a part of the narrowband corresponding to the narrowband index.

Or the CQI only consists of a CQI of a narrowband corresponding to the frequency-domain CSI reference resource. The CQI arrangement sequence of the CQI is preset, e.g., it is a sequence according to frequency from lower to high. For example, the CSI reference resource only corresponds to three narrowbands, and thus the CQIs of the three narrowbands are only reported.

e) reporting CQI of a narrowband corresponding to each subframe contained in the CSI reference resource. The CQIs of the narrowbands are arranged according to a preset sequence; and alternatively, the preset sequence may be, for example, a progressive increase or progressive decrease sequence of time.

The narrowbands on all time-domain CSI reference resources may be not overlapped and may also be overlapped. As illustrated in FIG. 8, CQIs consist of CQIs of subframes #4 to #8, herein narrowbands corresponding to subframe 6 and subframe 7 are overlapped.

A CQI of a bandwidth (which may be a narrowband in a-e of this example or an aggregate narrowband such as the first bandwidth or the second bandwidth) may be a CQI value such as a CQI which reflects channel quality of a first code word, and may also be multiple CQI values such as CQIs which respectively reflect channel qualities of two code words.

In the above-mentioned reporting mode, the CQI values may be absolute values and may also be relative values such as an offset value relative to a broadband CQI. The broadband CQI may be an average value of CQIs within a period of time. Under this situation, the broadband CQI is reported before reporting at this time. The CQI values may also consist of absolute values and relative values, e.g., consist of an absolute value of a broadband CQI and multiple narrowband CQIs relative to the broadband CQI. The broadband CQI here may be an average value of CQIs within a period of time or an average value of CQIs of the reported narrowbands, or may be an absolute value which reflects channel quality of a first code word and a relative value which reflects channel quality of a second code word. The relative value is relative to the absolute value of the channel quality of the first code word.

By taking that channel quality of two code words is reported as an example, mode 1 is that the CQI values are absolute values, for example, including two absolute CQI values which reflect channel quality of two code words (CQI values are 4-bit CQI index values). Mode 2 is that the CQI values are absolute values and relative values, for example, including an absolute CQI value which reflects channel quality of a first code word and a relative CQI value which reflects channel quality of a second code word, herein the relative CQI value is an offset relative to the absolute CQI value which reflects the channel quality of the first code word. Mode 3 is that the CQI values are absolute values, for example, including a relative CQI value CQI1 which reflects channel quality of a first code word and a relative CQI value CQI2 which reflects channel quality of a second code word, herein CQI1 and CQI2 are both offsets relative to an absolute CQI value which reflects channel quality of a broadband.

With respect to the situation of measurement based on CSI-RS, the CSI-RS may be the existing CSI-RS or a truncated CSI-RS in a narrowband, and the bandwidth of the truncated CSI-RS does not exceed the narrowband.

A channel for reporting the CSI may be a PUCCH (Physical Uplink Control Channel) and may also be a PUSCH (Physical Uplink Shared Channel). Alternatively, the PUSCH resource may be scheduled by the eNB and may also be preset.

Besides, the embodiment of the present disclosure further includes a terminal, including a processor and a communication unit. The processor is configured to determine a CSI reference resource, the CSI reference resource is one or more subframes in a time domain and one or more narrowbands in a frequency domain. The communication unit is configured to report the CSI on the CSI reference resource.

Besides, the embodiment of the present disclosure further provides a computer-readable storage medium, storing computer-executable instructions, which, when executed, implement the method for reporting CSI by UE.

Besides, the embodiment of the present disclosure further provides a computer-readable storage medium, storing computer-executable instructions, which, when executed, implement the method for triggering UE to report CSI.

One skilled in the art can understand that all or partial steps in the above-mentioned methods may be completed by relevant hardware (such as a processor) instructed by a program. The program may be stored in a computer readable storage medium such as a read-only memory, a magnetic disc or a compact disc. Optionally, all or partial steps in the above-mentioned embodiments may also be implemented by using one or more integrated circuits. Correspondingly, each module/unit in the above-mentioned embodiments may be implemented by means of hardware, e.g., a corresponding function thereof may be implemented through an integrated circuit. It may also be implemented by means of a software function module, e.g., a corresponding function thereof may be implemented through a processor which executes program/instructions stored in a memory. The present disclosure is not limited to combinations of hardware and software in any specific form.

Although the implementation modes disclosed by the present disclosure are described above, the contents are only implementation modes used for facilitating the understanding about the present application and instead of limiting the present disclosure. One skilled in the art may make any modification and variation to the implementation modes and details without departing from the essence and scope disclosed by the present application. However, the patent protection scope of the present application shall be still subject to the scope defined by the appended claims.

### INDUSTRIAL APPLICABILITY

The embodiments of the present disclosure provide a method and a device for reporting CSI by UE and triggering UE to report CSI, which enable the UE to reporting CSI of a narrowband and are particularly applicable to user equipment having a limited receiving capability. Since the UE measures the narrowband on one or more subframes, the problem that MTC UE cannot report the CSI is solved and the effect is better for MTC UE which supports small RF bandwidth.

1. A method for reporting Channel State Information, CSI, by User Equipment, UE, comprising:
UE determining a CSI reference resource, reporting CSI on the CSI reference resource, wherein the CSI reference resource is one or more subframes in a time domain and one or more narrowbands in a frequency domain.

2. The method according to claim 1, wherein reporting CSI on the CSI reference resource comprises:
the UE periodically reporting the CSI on the CSI reference resource; or
the UE reporting the CSI on the CSI reference resource after receiving information about triggering CSI report, and,
the information about triggering CSI report is contained in Downlink Control Information, DCI, or a Random Access Response, RAR, and,
the DCI is DCI for scheduling a Physical Uplink Shared Channel, PUSCH, or DCI for scheduling a Physical Downlink Shared Channel, PDSCH, or dedicated DCI.

3. (canceled)

4. (canceled)

5. The method according to claim 2, wherein, when the UE reports the CSI on the CSI reference resource according to a preset period, that the CSI reference resource is one or more subframes in a time domain and one or more narrowbands in a frequency domain refers to that:
a. the CSI reference resource is a downlink subframe in the time domain, the downlink subframe is a subframe before a preset subframe, and the CSI reference resource is a narrowband corresponding to the downlink subframe in the frequency domain; or
b. the CSI reference resource is a predesignated narrowband in the frequency domain and is one or more downlink subframes corresponding to the predesignated narrowband in the time domain, and the downlink subframe is a subframe before a preset subframe; or
c. the CSI reference resource is a narrowband different from narrowbands corresponding to CSI reported at previous K times in the frequency domain, where K is a positive integer, K<N and N is a total number of narrowbands which need to be measured; and is one or more downlink subframes corresponding to the narrowband in the time domain, and the downlink subframe is a subframe before a preset subframe; or
d. the CSI reference resource is one or more downlink subframes in a time window in the time domain, and is a narrowband corresponding to the one or more downlink subframes in the frequency domain t, and,
the narrowband corresponding to the downlink subframe is a preset or configured narrowband.

6. (canceled)

7. The method according to claim 2, wherein, when the UE reports the CSI on the CSI reference resource after receiving the information about triggering CSI report, the information about triggering CSI report is contained in Downlink Control Information, DCI, or a Random Access Response, RAR; and that the CSI reference resource is one or more subframes in the time domain and is one or more narrowbands in the frequency domain refers to that:
a. the CSI reference resource is a downlink subframe for receiving the DCI in the time domain and is a narrowband corresponding to the downlink subframe in the time domain; or
b. the CSI reference resource is a downlink subframe where a Physical Downlink Shared Channel, PDSCH, scheduled through the DCI is located in the time domain, and is a narrowband corresponding to the downlink subframe in the frequency domain; or
c. the CSI reference resource is one or more downlink subframes in a time window in the time domain and is a narrowband corresponding to the one or more downlink subframes in the frequency domain; or
d. the CSI reference resource comprises a resource indicated in the DCI or RAR, and,
in the c, the narrowband corresponding to the downlink subframe is a preset or configured narrowband.

8. (canceled)

9. The method according to claim 5, wherein the time window is configured or preset, and,
the narrowband corresponding to partial or all downlink subframes in the time window is a preset or configured narrowband.

10. (canceled)

11. The method according to claim 3, wherein,
a subframe for reporting the CSI is one of the following:
a subframe scheduled through first DCI or RAR for sending the PUSCH, wherein the first DCI is DCI containing information about triggering CSI report, the UE reports the CSI according to the information about triggering CSI report;
a subframe scheduled through second DCI for sending the PUSCH, wherein previous DCI of the second DCI is DCI containing information about triggering CSI report, the UE reports the CSI according to the information about triggering CSI report; and
an (n+k)th subframe, where n is a subframe where the DCI or RAR containing information about triggering CSI report is located and k is a positive integer greater than 0 and not less than a preset value, and,
wherein the DCI or RAR further contains CSI reference resource information of the UE.

12. (canceled)

13. (canceled)

14. The method according to claim 1, wherein reporting the CSI on the CSI reference resource comprises:
reporting a Channel Quality Indicator, CQI, on the CSI reference resource; or
reporting a narrowband index and a CQI of a narrowband corresponding to the narrowband index; or
reporting a subframe index and a CQI of a narrowband corresponding to the subframe index; or
reporting CQIs of narrowbands arranged according to a preset sequence in the frequency domain; or
reporting a CQI of a narrowband corresponding to each subframe contained in the CSI reference resource, wherein the CQIs of the narrowbands are arranged according to a preset sequence.

15. The method according to claim 14, wherein the CQI of the narrowband corresponding to the narrowband index comprises at least one of the following:
a CQI on a first bandwidth, wherein the first bandwidth consists of all narrowbands corresponding to the narrowband indexes; and
a CQI of each narrowband corresponding to the narrowband index, or,
the CQI of the narrowband corresponding to the subframe index comprises at least one of the following:
a CQI on a second bandwidth, wherein the second bandwidth consists of all narrowbands corresponding to the subframe indexes; and
a CQI of each narrowband corresponding to the subframe index.

16. (canceled)

17. The method according to claim 14, wherein the CQI is an absolute value and/or relative value, and,
the CSI further comprises at least one of the following information:
Precoding Matrix Indicator, PMI, on the CSI reference resource, Precoding Type Indicator, PTI, on the CSI reference resource, and Rank Indication, RI, on the CSI reference resource.

18. (canceled)

19. The method according to claim 1, wherein that the CSI reference resource is one or more subframes in the time domain comprises that:
the CSI reference resource is a subframe for the UE to receive control information and/or downlink data in the time domain, or a subframe in a measurement subframe set.

20. The method according to claim 19, wherein, when the CSI reference resource is the subframe in the measurement subframe set, that the CSI reference resource is one or more narrowbands in the frequency domain comprises that:
the CSI reference resource is a first narrowband which is preset or notified by a base station eNB in the frequency domain, wherein the UE receives a downlink signal on the subframe in the measurement subframe set and on the first narrowband, and,
when a narrowband for receiving a control signal and/or downlink data is not overlapped with the first narrowband on the subframe in the measurement subframe set, receiving the control signal and/or data signal is given up.

21. (canceled)

22. The method according to claim 19, wherein, when the CSI reference resource is a subframe for the UE to receive control information and/or downlink data in the time domain, that the CSI reference resource is one or more narrowbands in the frequency domain comprises that:
a narrowband corresponding to the subframe for receiving control information and/or downlink data traverses all available narrowbands within a period of time.

23. The method according to claim 1, wherein a subframe of the CSI reference resource in the time domain is an effective downlink subframe, wherein the effective downlink subframe satisfies at least one of the following conditions:
the subframe is a downlink subframe;
the subframe is not a Multicast Broadcast Single Frequency Network, MBSFN, subframe except in a transmission mode 9 or a transmission mode 10;
the subframe does not contain a Downlink Pilot Time Slot, DwPTS, with a length less than or equal to 7680·Tₛ, where Tₛ is a time unit;
the subframe is not within a configured measurement gap; and
when the UE is configured with a CSI subframe set, the subframe is a subframe in the CSI subframe set.

24. The method according to claim 23, wherein that the CSI reference resource is one or more subframes in the time domain comprises that:
the time-domain CSI reference resource is one or more downlink subframes closest to a report subframe in subframes before a preset subframe.

25. The method according to claim 1, wherein that the CSI reference resource is one or more subframes in the time domain comprises that:
the CSI reference resource is one or more downlink subframes closest to a report subframe in subframes before a preset subframe in the time domain, and,
a CSI-Reference Signal, CSI-RS, on one subframe in one or more subframes of the CSI reference resource in the time domain does not exceed a bandwidth corresponding to the subframe in the frequency domain.

26. (canceled)

27. The method according to claim 1, wherein reporting the CSI on the CSI reference resource further comprises:
reporting the CSI through a Physical Uplink Control Channel, PUCCH, or a Physical Uplink Shared Channel, PUSCH, and
the PUSCH resource is preset.

28. (canceled)

29. The method according to claim 19, wherein the measurement subframe set is predefined or notified by a base station eNB, and,
the method further comprises: the UE receiving a downlink signal on a subframe in the measurement subframe set and on a narrowband which is preset or notified by a base station eNB, and,
the method further comprises: when a narrowband for the UE to receive a control signal and/or a data signal is not overlapped with the narrowband which is preset or notified by the base station eNB on the subframe in the measurement subframe set, giving up receiving the control signal and/or the data signal on the narrowband for receiving the control signal and/or the data signal.

30-32. (canceled)

33. A method for triggering User Equipment, UE, to report Channel State Information, CSI, comprising:
a network side sending the following contents to UE: a reference signal, related resource information about periodically reporting and/or related resource information about triggering report.

34-42. (canceled)

43. A device for reporting Channel State Information, CSI, located in User Equipment, UE, comprising a CSI reference resource determination module and a reporting module, wherein:
the CSI reference resource determination module is configured to determine a CSI reference resource, wherein the CSI reference resource is one or more subframes in a time domain and one or more narrowbands in a frequency domain; and
the reporting module is configured to report CSI on the CSI reference resource.

44-74. (canceled)

75. A device for triggering User Equipment, UE, to report Channel State Information, CSI, comprising:
a first sending module configured to send a reference signal to UE; and
a second sending module configured to send the following contents to the UE: related resource information about periodically reporting and/or related resource information about triggering report.

76-84. (canceled)
